(19) United States
(12) Patent Application Publication
(10) Pub. No.: US 2017/0226782 A1
(43) Pub. Date: Aug. 10, 2017

(54) HINGE-SUPPORTED DOOR HOLDER

(71) Applicant: David D. Holden, Worcester, MA (US)

(72) Inventor: David D. Holden, Worcester, MA (US)

(21) Appl. No.: 15/407,488

(22) Filed: Jan. 17, 2017

Related U.S. Application Data
(60) Provisional application No. 62/279,727, filed on Jan. 16, 2016.

(51) Int. Cl. E05C 17/54; E05C 17/00

(52) U.S. Cl. CPC E05C 17/54; E05C 17/025

(57) ABSTRACT

A selectively settable and removable door holder is configured for setting atop the hinge-pin head of a door hinge assembly in order to prevent a door supported by the door hinge assembly from closing beyond a predetermined minimum door angle. The door holder is defined by a plate-like body having opposed first and second sides extending longitudinally along a central axis between holder first and second ends and a shape-defining body perimeter extending between the opposed first and second sides. A central hinge-rest region configured for setting atop the hinge-pin head is situated between the holder first and second ends. Sub-portions of the body perimeter define door-engaging and door-frame-engaging edges that mutually diverge away from the hinge-rest region toward the first end. A tail portion is defined by tail first and second edges that mutually diverge away from the hinge-rest region toward the holder second end.

### PROVISIONAL PRIORITY CLAIM

Priority based on Provisional Application, Ser. No. 62/279,727 filed Jan. 16, 2016, and entitled “HINGE-SUPPORTED DOOR HOLDER” is claimed. Moreover, the entirety of the previous provisional application, including the drawings, is incorporated herein by reference as if set forth fully in the present application.

### BACKGROUND

Devices for temporarily holding doors open at a desired angle relative to the closed position (e.g., 0-degrees) are already commercially available. Two main types include (i) “free wedges” and (ii) attached post-and-foot systems.

A “free wedge” may be made of wood, rubber, metal, etc. and is essentially wedge that is jammed between a floor and the lower edge of a hinged door that swings over the floor in order to prevent the door from closing—or even moving—when a desired door orientation is established. Such wedges are well-known and ubiquitous, and are frequently improvised by simply cutting a block of wood into a wedge configuration.

Another type of door holder is characterized by a simple post that is often slightly angled and includes upper and lower post ends. The upper post end is pivotably mounted to the inside vertical surface of the door a few inches above the door's lower edge. The post is mounted such that it is pivotable about a horizontal axis. The lower post end terminates in a foot configured to selectively engage the floor with a coefficient of friction sufficiently high to retain the door in place. The post is pivotable between an engaged, door-holding position in which the foot engages the floor as described and an upper, disengaged position in which the post is pivoted upwardly such the foot is disengaged from the floor.

The devices above, and other existing devices, are particularly useful in keeping open a door that is normally biased toward a closed position by a biasing member such as a spring or other “door-pulling” device. However, one issue associated with “free wedges” is that a user must frequently bend downward to manually place the wedge in an appropriate location before setting (jamming) it under the door with the assistance of his or her foot, for example. Moreover, wedges are frequently misplaced. A disadvantage associated with post-and-foot systems such as the illustrative generic example described above is that they require permanent mounting to a door and can also require the intervention of a user's hand to function properly.

Another type of door-retaining or, more accurately, swing-limiting device is a door stop through which a hinge pin is passed. These are semi-permanent devices and are used most frequently to prevent doors from opening beyond a predetermined angle, an angle that is often adjustable. Such devices are used, for example, to prevent doors from opening far enough to contact furniture or a wall adjacent to a wall in which a door is mounted. Such devices are generally unsuitable for use in temporarily preventing a door from closing because they must be removed in order to allow door closure, and such removal requires removal of the hinge pin by which the device is retained atop a hinge assembly.

Accordingly, a need exists for a simple, portable door holder that lacks the complexity of a permanent door stop and the inconvenience of the free wedge jammed between the floor and a door's lower edge.

### SUMMARY

Alternative embodiments of a portable hinge-supported door holder are configured for setting atop a hinge-pin head of a door hinge assembly in order to prevent a door supported by the door hinge assembly from closing beyond a predetermined minimum door angle. An illustrative configuration includes a substantially planar plate-like body having opposed first and second sides extending longitudinally along a central axis between holder first and second ends, while a shape-defining body perimeter extends between the opposed first and second sides. Situated between the holder first and second ends is a hinge-rest region configured for setting atop the hinge-pin head.

Sub-portions of the body perimeter define door-engaging edge and a frame-engaging edges that mutually converge away from the holder first end toward the hinge-rest region. Across the hinge-rest region from the door-engaging edge and a frame-engaging edges, a tail portion extends between the hinge-rest region and the holder second end. The tail portion is defined by tail first and second edges that mutually diverge away from the hinge-rest region toward the holder second end. In various configurations, the plate-like body is generally symmetrical about the central axis between the holder first and second ends.

In each of several alternative embodiments, the door holder is selectively retained in place atop the hinge-pin head with the aid of magnetism. Retention by magnetism can be achieved in various ways that render the hinge-pin head magnetically-responsive (i.e., magnetically attractive) to the hinge-rest region. For example, the hinge-pin may have permanently affixed thereto a first magnet while the door holder includes a second magnet within the hinge-rest region configured for selective magnetic attraction to the first magnet. Alternatively, one of the hinge-pin head and the door holder could incorporate a magnet while the other of the door holder and hinge-pin head could comprise a ferromagnetic material that is attractive the magnet.

It is envisioned in association with at least one embodiment that, when not in use, a door holder including a magnetic hinge-rest region may, by such magnetism, be conveniently stored for ready access adjacent a door on which it is intended for use. For example, in a case in which the hinge-rest region includes a magnet, the door holder may be selectively supported by magnetically-responsive object or structure, such as a metal door frame or metal desk near the door. In cases in which no suitable nearby object or structure exists, a third magnet may be mounted near the door on an object or structure such as the door frame or the wall adjacent thereto. Although no such third magnet is depicted in the drawings associated with the present specification, textual disclosure alone is so readily understandable as to render unnecessary graphic depiction of same in order to support its inclusion as a claim element.

Representative embodiments are more completely described and depicted in the following detailed description and the accompanying drawings.

### BRIEF DESCRIPTION OF THE DRAWINGS

FIG. 1 includes an upper figure portion depicting an illustrative portable door holder configured in accordance within the parameters of the inventive concept and a lower figure portion depicting an illustrative hinge assembly with which the door holder can cooperate;

FIG. 2 shows a user's hand setting a door holder in place atop a door hinge assembly; and

FIG. 3 shows an alternatively configured door holder having a generally plate-like body with frame-engaging and door-engaging edges defined by and along flanged portions of the plate-like body.

### DETAILED DESCRIPTION

The following description of variously embodied hinge-supported door holders is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to restrict the maximum scope of the claims. Moreover, among the various depicted embodiments, like reference numbers are used to refer to similar or analogous components.

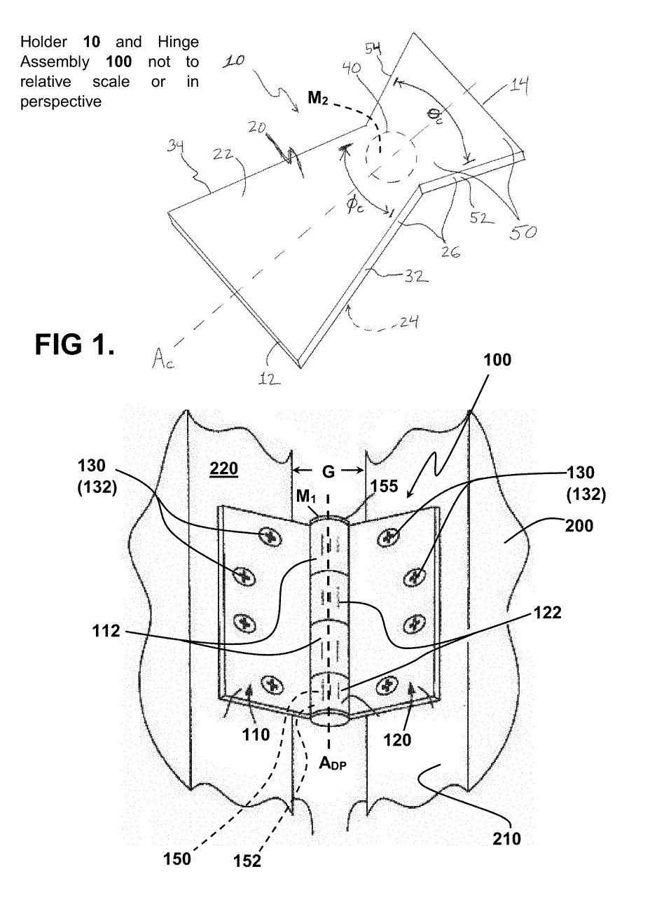

Referring initially to FIG. 1, an illustrative hinge-supported door holder 10 (hereinafter alternatively referred to as “door holder 10”) is configured for cooperative support by a door-hinge assembly 100. The door-hinge assembly 100 is typical in that it includes first and second hinge leaves, which are referred to interchangeably as, respectively, first and second hinge plates 110 and 120. The identification of the hinge plates as first and second hinge plates 110 and 120 is entirely arbitrary, but for the sake of consistency in the discussion the door-hinge assembly 100 supports a door 200 to a vertical door frame member 220 with the first hinge plate 110 secured to the vertical door frame member 220 and the second hinge plate 120 secured to a vertically-extending door inside edge 210.

In the exemplary environment, the hinge plates 110 and 120 are secured to, respectively, the vertical door frame member 220 and the door inside edge 210 with hinge-plate fasteners 130, such as screws 132. The first hinge plate 110 defines first-plate pin sleeves 112, while the second hinge plate 120 defines second-plate pin sleeves 122. The door 200 is hung by aligning in alternating juxtaposition the fist-plate and second-plate pin sleeves 112 and 122 along a common door-pivot axis ADP and introducing the cylindrical shaft 152 of a hinge pin 150 through the aligned pin sleeves 112 and 122. At one end of the shaft 152 (i.e., the end regarded as the top by convention) the hinge pin 150 includes an enlarged hinge-pin head 155 that prevents the hinge pin 150 from dropping from within the pin sleeves 112 and 122 under the force of gravity.

Referring to the upper portion of FIG. 1, in a most basic embodiment, a door holder 10 comprises a plate-like body 20 having opposed first and second sides 22 and 24 and a shape-defining body perimeter 26 extending between the first and second sides 22 and 24. The body 20 extends along a longitudinal central axis Ac between holder first and second ends 12 and 14 and, in various versions, is generally symmetrical about the central axis Ac.

Situated between the holder first and second ends 12 and 14 is a hinge-rest region 40 configured for setting atop the hinge-pin head 155. Extending from the first holder end 12, and mutually converging toward the hinge-rest region 40 are a door-engaging edge 32 and a frame-engaging edge 34. Each of these edges 32 and 34, the purpose of which will be explained later in this description, is a sub-portion of the body perimeter 26. In the versions depicted in the drawings, the body 20 of the door holder 10 further defines a tail portion 50. The tail portion 50 extends between the holder second end 14 and the hinge-rest region 40. In the particular versions shown, the tail portion 50 is defined by straight tail first and second edges 52 and 54 that mutually diverge away from the hinge-rest region 40 toward the holder second end 14.

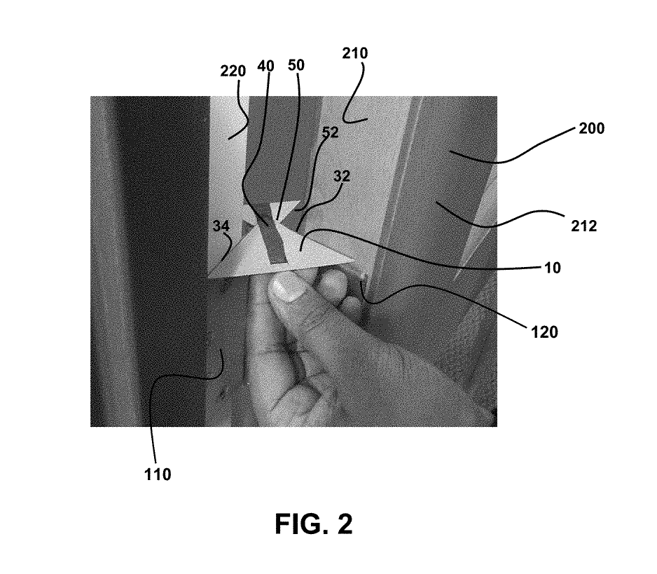

In FIG. 2, a user is setting a door holder 10 in place atop a hinge-pin head 155 (obstructed) of a door-hinge assembly 100 (partially obstructed) in order to keep the door 200 shown in an open position. For the purpose of clarity, not all reference numbers are used in FIG. 2, but they can be easily gleaned by reference to FIG. 1. In order to set the door holder 10 in place atop the hinge-pin head 155, the door holder 10 is turned from a position other than flat/horizontal in order to introduce and situate the tail portion 50 through the gap G between the door inside edge 210 to which the second hinge plate 120 is secured and the vertical door frame member 220 to which the first hinge plate 110 is attached.

Once the tail portion 50 is to the outside of the door 200, and protruding through the gap G, the holder 10 is rotated to a flat orientation and “set” such that the hinge-rest region 40 rests atop the hinge-pin head 155 (obstructed, but readily understood). The door 200 is then moved (i.e., pivoted) into a more closed position such that the door inside edge 210 is brought into contacting engagement with the door-engaging edge 32 of the door holder 10 and the frame-engaging edge 34 of the door holder 10 is brought into contacting engagement with the vertical door frame member 220. Of course, it will be readily appreciated relative to alternatively configured hinge assemblies 100 that the first and second hinge plates 110 and 120 could extend vertically above the hinge-pin head 155 and, in such a case, the second hinge plate 120 is brought into contacting engagement with the door-engaging edge 32 of the door holder 10 and the frame-engaging edge 34 of the door holder 10 is brought into contacting engagement with the first hinge plate 110. For purposes such as those of the latter scenario, the first hinge plate 110 is regarded as part of the vertical door frame member 220 and the second hinge plate 120 is regarded as part of the door inside edge 210.

In alternative scenarios, different forces will retain the door holder 10 in place atop the hinge-pin head 155 of the hinge pin 150. For instance, where the door 200 is normally biased toward a closed position, that positional bias will maintain the contacting engagement between, respectively, the frame-engaging edge 34 and the vertical door frame member 220 and the door-engaging edge 32 and door inside edge 210. However, there may be circumstances in which the door 200 in question is not biased toward a closed position. In one such scenario, the door holder 10 may be retained on the hinge pin by magnetism. Where the hinge pin 150 is fabricated from a ferromagnetic material, the hinge-rest region 40 of the door holder 10 may be provided with a magnet (not shown in FIG. 2). With reference back to FIG. 1, where neither the hinge pin 150 nor the door holder 10 is made from magnetic material, a first magnet M₁ can be permanently affixed to the top of the hinge-pin head 155 in order to magnetically engage a second magnet M₂ incorporated into or on the hinge-rest region 40 of the door holder 10. Of course, alternative quick-releasing adhering means may be employed, such as Velcro® brand hook-and-loop fasteners, but magnetism is a preferred option associated with various implementations.

It will be appreciated that where a door 200 is urged toward a closed position—either by a normal bias (e.g., by a spring) or by a person's pushing or pulling on it—there may be a tendency for the door holder 10 to “squirt out” from between the door inside edge 210 and the door frame member 220. In order to prevent this, the tail portion 50 is configured such that, when the door holder 10 is in a flat (horizontal) orientation upon the hinge pin 150, the horizontal extent (width) of the tail portion 50 is greater than the extent of the gap G between the door frame member 220 and the door inside edge 210. In this way, the tail portion 50 cannot be pulled through the gap G resulting in the door holder's 10 dropping to the floor or ground.

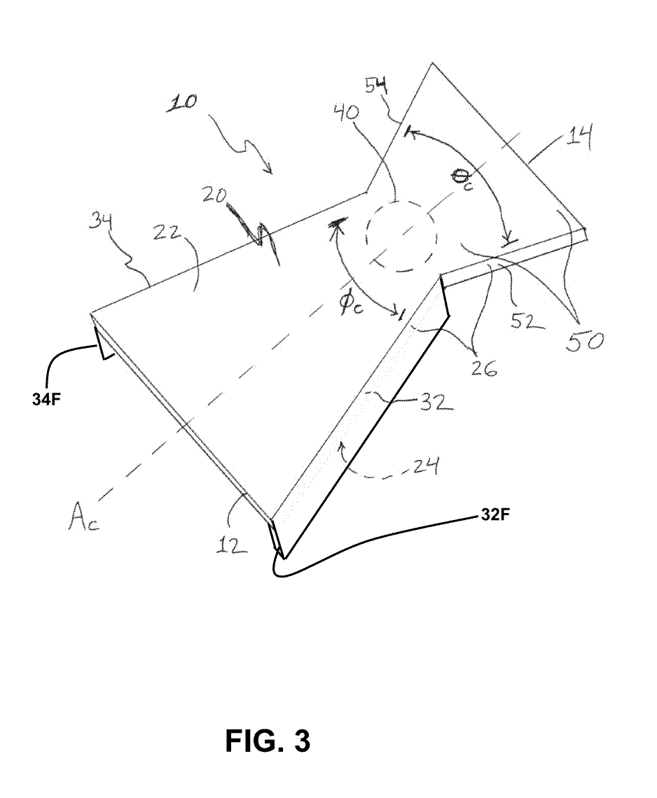

The door holder 10 can be made from various materials including, by way of non-limiting example, metal, plastic, rubber or wood. Regardless of the material from which the door holder 10 is fabricated, the thickness of the body perimeter 26 of plate-like body 20 may be “low profile,” as illustrated in both FIGS. 1 and 2, for instance. Where, for example, the body 20 is made from metal, such as sheet metal, the door-engaging and frame-engaging edges 32 and 34 may be very thin and, therefore, may cause damage (e.g., grove formation, not shown) in the door inside edge 210 and/or door frame 220. Because a thin profile is desirable from the standpoint of weight and material savings, measures need to be implemented to prevent door or frame damage. Accordingly, in one alternative configuration, an example of which is shown in FIG. 3, the door-engaging and frame-engaging edges 32 and 34 are defined on ______ or by ______, respectively, flanged portions 32F and 34F of the plate-like body 20 of the door holder 10. Where the door holder 10 is made from sheet metal, for example, this can be achieved simply by bending the metal plate/sheet 90-deg relative to the overall plane of the plate-like body 20.

The convergence angle Φ_{c} at which the frame-engaging and door-engaging edges 34 and 32 converge toward the hinge-rest region 40 defines the angle at which the door 200 will be maintained relative to the closed position. Referring to FIGS. 1 and 3, in at least one alternative version, the tail portion 50 also includes frame-engaging and door-engaging edges. More specifically, the tail first and second edges 52 and 54 can be configured to serve as frame-engaging and door-engaging edges. By fabricating the door holder 10 such that the frame-engaging and door-engaging edges 34 and 32 converging from the holder first end 12 converge at an angle Φ_{c} disparate from the angle θ_{c} at which the tail first and second edges 52 and 54 diverge from the hinge-rest region 40, the same door holder 10 may be used alternatively to hold open a door 200 at two different door angles. In such a case, it will be readily appreciated that the door holder 10 can be oriented such that the holder first end 12 serves as part of the “tail portion” when the holder 10 is so “reversed,” a scenario that is not shown, but which is nonetheless readily understandable based on the information explicitly provided, and therefore adequately disclosed.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A portable door holder configured for setting atop a hinge-pin head of a door hinge assembly in order to prevent a door supported by the door hinge assembly from closing beyond a predetermined minimum door angle, the door holder comprising:
a substantially planar plate-like body having opposed first and second sides extending longitudinally along a central axis between holder first and second ends, the plate-like body further having a shape-defining body perimeter extending between the opposed first and second sides;
a hinge-rest region situated between the holder first and second ends and configured for setting atop the hinge-pin head;
a door-engaging edge and a frame-engaging edge defined by sub-portions of the body perimeter and mutually converging away from the holder first end toward the hinge-rest region; and
a tail portion extending between the hinge-rest region and the holder second end and being defined by tail first and second edges that mutually diverge away from the hinge-rest region toward the holder second end.

2. The portable door holder of claim 1 wherein the plate-like body is generally symmetrical about the central axis.

3. The portable door holder of claim 1 configured for use in conjunction with a magnetically-responsive hinge-pin head wherein at least the hinge-rest region is magnetically attracted to the magnetically-responsive hinge-pin head in order to facilitate retention of the door holder atop the hinge-pin head.

4. The portable door holder of claim 3 wherein at least one of (i) the hinge-pin head is rendered magnetically responsive by the permanent affixation thereto of a first magnet and (ii) the door holder includes a second magnet within the hinge-rest region configured for selective magnetic attraction to the first magnet.

5. The portable door holder of claim 1 wherein the plate-like body is fabricated from sheet metal.

6. The portable door holder of claim 5 wherein the plate-like body is generally symmetrical about the central axis.

7. The portable door holder of claim 6 wherein the sheet metal is itself magnetically responsive.

8. The portable door holder of claim 5 wherein the sheet metal is itself magnetically responsive.

9. The portable door holder of claim 1 wherein the plate-like body is fabricated from a non-metal and the hinge-rest region incorporates a magnet.

10. The portable door holder of claim 1 wherein the door-engaging and frame-engaging edges are defined on flanged portions of the plate-like body.

11. The portable door holder of claim 10 wherein the plate-like body is fabricated from sheet metal.
